(19) United States
(12) Patent Application Publication
(10) Pub. No.: US 2021/0351433 A1
(43) Pub. Date: Nov. 11, 2021

(54) LITHIUM SOLID-STATE BATTERY

(71) Applicant: TOYOTA JIDOSHA KABUSHIKI KAISHA, Toyota-shi (JP)

(72) Inventor: Hiroyuki YAMAGUCHI, Susono-shi (JP)

(21) Appl. No.: 17/187,947

(22) Filed: Mar. 1, 2021

(30) Foreign Application Priority Data
Mar. 11, 2020 (JP) 2020-041813

(51) Int. Cl. H01M 10/0562; H01M 4/58; H01M 4/38; H01M 4/48

(52) U.S. Cl. CPC H01M 10/0562; H01M 4/48; H01M 4/386; H01M 4/5825

(57) ABSTRACT

Provided is a lithium solid-state battery having high thermal stability and low resistance. A lithium solid-state battery comprising: a cathode comprising a cathode layer that contains an oxide-based cathode active material, an anode comprising an anode layer that contains an anode active material, and a solid electrolyte layer being disposed between the cathode layer and the anode layer and containing a solid electrolyte, wherein at least any one of the anode layer and the solid electrolyte layer contains a sulfide-based solid electrolyte, and wherein the anode layer contains at least one phosphorus-based ester compound selected from the group consisting of a phosphoric acid ester, a phosphoric acid ester, a phosphinic acid ester, a phosphorous acid ester and a phosphoric acid ester amide.

### TECHNICAL FIELD

The disclosure relates to a lithium solid-state battery.

### BACKGROUND

In the field of solid-state batteries, there are attempts to enhance the thermal stability of a solid-state battery.

For example, Patent Literature 1 discloses a lithium solid-state battery in which the cathode active material layer contains a phosphoric acid ester.

As a technique in which a phosphoric acid ester is used as a flame retardant, Patent Literature 2 discloses a fluorine-containing phosphoric acid ester as a flame retardant composition for polymer solid electrolyte.

Patent Literature 3 discloses an electrolyte solution composition for lithium ion secondary battery, the composition comprising a phosphoric acid ester having a fluorinated alkyl group as a fire retardant.

Patent Literature 1: Japanese Patent Application Laid-Open (JP-A) No. 2017-112041

Patent Literature 2: JP-A No. 2003-238821

Patent Literature 3: JP-A No. 2019-079781

As a result of research, it was found that when the cathode active material layer of a lithium solid-state battery contains, as disclosed in Patent Literature 1, a phosphoric acid ester, there is a problem in that the resistance of the lithium solid-state battery increases while the thermal stability increases.

### SUMMARY

The disclosed embodiments were achieved in light of the above circumstances. An object of the disclosed embodiments is to provide a lithium solid-state battery having high thermal stability and low resistance.

In a first embodiment, there is provided a lithium solid-state battery comprising:

a cathode comprising a cathode layer that contains an oxide-based cathode active material, an anode comprising an anode layer that contains an anode active material, and a solid electrolyte layer being disposed between the cathode layer and the anode layer and containing a solid electrolyte,

wherein at least any one of the anode layer and the solid electrolyte layer contains a sulfide-based solid electrolyte, and

wherein the anode layer contains at least one phosphorus-based ester compound selected from the group consisting of a phosphoric acid ester, a phosphoric acid ester, a phosphinic acid ester, a phosphorous acid ester and a phosphoric acid ester amide.

A content of the phosphorus-based ester compound in the anode layer may be 1 mass % or more and 10 mass % or less when a total mass of the anode layer is determined as 100 mass %.

The anode active material may be at least one selected from the group consisting of elemental Si and Si alloy.

The phosphorus-based ester compound may contain a fluorinated alkyl group.

According to the disclosed embodiments, the lithium solid-state battery having high thermal stability and low resistance can be provided.

### BRIEF DESCRIPTION OF THE DRAWING

FIG. 1 is a schematic sectional view of an example of the lithium solid-state battery of the disclosed embodiments.

### DETAILED DESCRIPTION

The lithium solid-state battery according to the disclosed embodiments is a lithium solid-state battery comprising:

a cathode comprising a cathode layer that contains an oxide-based cathode active material, an anode comprising an anode layer that contains an anode active material, and a solid electrolyte layer being disposed between the cathode layer and the anode layer and containing a solid electrolyte,

wherein at least any one of the anode layer and the solid electrolyte layer contains a sulfide-based solid electrolyte, and

wherein the anode layer contains at least one phosphorus-based ester compound selected from the group consisting of a phosphoric acid ester, a phosphoric acid ester, a phosphinic acid ester, a phosphorous acid ester and a phosphoric acid ester amide.

As described in Patent Literature 1, it was considered that when a phosphorus-based ester compound such as a phosphoric acid ester is used in the anode layer of a lithium solid-state battery, there is a possibility such that once the phosphorus-based ester compound permeates into the anode layer, the reductive decomposition of the phosphorus-based ester compound occurs.

However, it was found that even when the phosphorus-based ester compound is contained in the anode layer, surprisingly, the phosphorus-based ester compound is stably present in the anode layer, and the resistance of the lithium solid-state battery does not increase. Also, it was found that the lithium solid-state battery in which the phosphorus-based ester compound is used in the anode layer, can suppress that the anode active material causes a decomposition reaction and heat generation. Accordingly, the lithium solid-state battery in which the phosphorus-based ester compound is used in the anode layer, can achieve desired thermal stability, without an increase in the resistance.

In the disclosed embodiments, the exothermic peak temperature of the lithium solid-state battery can be shifted to the high temperature side by using the specific phosphorus-based ester compound. The mechanism is estimated as follows.

For example, due to the overcharging of the lithium solid-state battery, the oxide-based cathode active material of the cathode layer is decomposed to produce oxygen from the cathode layer. Then, the oxygen transfers to the anode layer. By the phosphorus-based ester compound contained in the anode layer, an active species derived from the oxygen is trapped. Due to the above reason, a heat generation reaction of the lithium solid-state battery arising from the oxygen generation, is estimated to be suppressed.

Two or more phosphorus-based ester compounds are condensed to form a coating film on the surface of the anode active material. It is estimated that due to the presence of the coating film between the anode active material and the sulfide-based solid electrolyte, a reaction between the anode active material and the sulfide-based solid electrolyte is suppressed, thereby suppressing the heat generation reaction of the lithium solid-state battery.

Once the lithium solid-state battery is exposed to high temperature, an oxygen radical (O radical) is produced from the oxide-based cathode active material. When the phosphorus-based ester compound contains the fluorinated alkyl group, a radical derived from the fluorinated alkyl group is produced simultaneously with the oxygen radical production. The oxygen radical is fixed by the radical derived from the fluorinated alkyl group, thereby suppressing the heat generation reaction of the lithium solid-state battery arising from the oxygen radical production. Accordingly, the thermal stability of the lithium solid-state battery is estimated to increase.

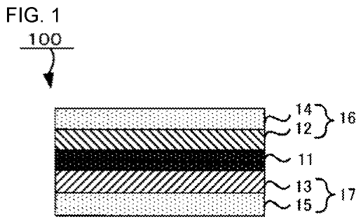

FIG. 1 is a schematic sectional view of an example of the lithium solid-state battery of the disclosed embodiments.

A solid-state battery 100 comprises a cathode 16, an anode 17 and a solid electrolyte layer 11. The cathode 16 comprises a cathode layer 12 and a cathode current collector 14. The anode 17 comprises an anode layer 13 and an anode current collector 15. The solid electrolyte layer 11 is disposed between the cathode 16 and the anode 17.

### [Cathode]

The cathode comprises at least the cathode layer. As needed, it comprises the cathode current collector for collecting current from the cathode layer.

The cathode layer contains at least the oxide-based cathode active material as the cathode active material. As needed, it contains an electroconductive material, a binder, a solid electrolyte, a phosphorus-based ester compound, etc.

The oxide-based cathode active material may contain an O element.

As the oxide-based cathode active material, examples include, but are not limited to, Li₂TiO₃, Li₂Ti₃O₇, Li₄Ti₅O₁₂, LiCoO₂, LiMnO₂, LiNiO₂, LiVO₂, LiNiₓCo₁₋ₓO₂ (where 0<x<1), LiNixCo_{y}Mn_{z}O₂ (where x+y+z=1), LiMn₂O₄, Li₂MnO₃, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, LiMn_{1.5}Zn_{0.5}O₄, LiFePO₄, LiMnPO₄, LiCoPO₄, LiNiPO₄, Li₂SiO₃, Li₄SiO₄, V₂O₅, MoO₃ and SiO₂.

As long as the cathode layer contains, as a main component, the oxide-based cathode active material as the cathode active material, the cathode layer may also contain a conventionally-known, non-oxide-based cathode active material as the cathode active material.

As the non-oxide-based cathode active material, examples include, but are not limited to, elemental Li, Li alloy, elemental Si, Si alloy, LiCoN, TiS₂, Mg₂Sn, Mg₂Ge, Mg₂Sb and Cu₃Sb.

As the Li alloy, examples include, but are not limited to, Li—Au, Li—Mg, Li—Sn, Li—Si, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te and Li—At. As the Si alloy, examples include, but are not limited to, alloys with metals such as Li. Also, the Si alloy may be an alloy with at least one kind of metal selected from the group consisting of Sn, Ge and Al.

A coating layer containing a Li ion conducting oxide, may be formed on the surface of the cathode active material. That is, the cathode active material may be such a cathode active material composite, that the coating layer is formed on the surface of the cathode active material. This is because a reaction between the cathode active material and the solid electrolyte can be suppressed.

As the Li ion conducting oxide, examples include, but are not limited to, LiNbO₃, Li₄Ti₅O₁₂ and Li₃PO₄. The thickness of the coating layer is 0.1 nm or more, for example, and it may be 1 nm or more. On the other hand, the thickness of the coating layer is 100 nm or less, for example, and it may be 20 nm or less. Also, for example, 70% or more or 90% or more of the cathode active material surface may be coated with the coating layer.

The method for coating the surface of the cathode active material with the Li ion conducting oxide is not particularly limited. As the method, examples include, but are not limited to, a method of coating the cathode active material with the Li ion conducting oxide in the air environment by use of a tumbling/fluidizing coater (manufactured by Powrex Corporation) and firing the cathode active material coated with the Li ion conducting oxide in the air environment. The examples also include, but are not limited to, a sputtering method, a sol-gel method, an electrostatic spraying method and a ball milling method.

The form of the cathode active material is not particularly limited. As the form, examples include, but are not limited to, a particulate form and a plate form.

The content of the cathode active material in the cathode layer is not particularly limited. When the total mass of the cathode layer is determined as 100 mass %, the content of the cathode active material may be from 50 mass % to 90 mass %, for example.

As the solid electrolyte, examples include, but are not limited to, materials exemplified below for the solid electrolyte layer.

The content of the solid electrolyte in the cathode layer is not particularly limited. When the total mass of the cathode layer is determined as 100 mass %, the content of the solid electrolyte may be from 1 mass % to 80 mass %, for example.

The binder is not particularly limited. As the binder, examples include, but are not limited to, acrylonitrile butadiene rubber (ABR), butadiene rubber (BR), polyvinylidene fluoride (PVdF) and styrene-butadiene rubber (SBR). The content of the binder in the cathode layer is not particularly limited.

As the electroconductive material, a known electroconductive material may be used. As the electroconductive material, examples include, but are not limited to, a carbonaceous material and a metal material. The carbonaceous material may be at least one selected from the group consisting of vapor-grown carbon fiber (VGCF), carbon nanotube, carbon nanofiber and carbon black such as acetylene black and furnace black. Of them, the electroconductive material may be at least one selected from the group consisting of VGCF, carbon nanotube and carbon nanofiber, from the viewpoint of electron conductivity. As the metal material, examples include, but are not limited to, Ni, Cu, Fe and SUS.

The content of the electroconductive material in the cathode layer is not particularly limited.

As the phosphorus-based ester compound, examples include, but are not limited to, materials exemplified below for the anode layer.

The content of the phosphorus-based ester compound in the cathode layer is not particularly limited. When the total mass of the cathode layer is determined as 100 mass %, the content may be from 0.1 mass % to 20 mass %, for example, or it may be from 1 mass % to 10 mass %.

When the content of the phosphorus-based ester compound in the cathode layer is less than 0.1 mass %, there is a possibility that the thermal stability is not sufficiently increased. On the other hand, when the content of the phosphorus-based ester compound in the cathode layer is more than 20 mass %, the content of the cathode active material is relatively small, and there is a possibility that the capacity of the battery is not sufficient.

The thickness of the cathode layer is not particularly limited. For example, it may be from 10 μm to 250 μm.

The cathode layer may be formed by the following method, for example. A cathode layer slurry is produced by putting the oxide-based cathode active material and, as needed, other components in a solvent and mixing them. The cathode layer slurry is applied on one surface of a support such as the cathode current collector. The applied slurry is dried, thereby obtaining the cathode layer.

As the solvent, examples include, but are not limited to, butyl acetate, butyl butyrate, heptane and N-methyl-2-pyrrolidone.

The method for applying the cathode layer slurry on one surface of the support such as the cathode current collector, is not particularly limited. As the method, examples include, but are not limited to, a doctor blade method, a metal mask printing method, an electrostatic coating method, a dip coating method, a spray coating method, a roller coating method, a gravure coating method and a screen printing method.

The support may be appropriately selected from self-supporting supports, and it is not particularly limited. For example, a metal foil such as Cu and Al may be used as the support.

The cathode layer may be formed by another method such as pressure-forming a powdered cathode mixture that contains the oxide-based cathode active material and, as needed, other components. In the case of pressure-forming the powdered cathode mixture, generally, a press pressure of about 1 MPa or more and about 600 MPa or less is applied.

The pressure applying method is not particularly limited. As the method, examples include, but are not limited to, pressing by use of a plate press machine, a roll press machine or the like.

The cathode current collector functions to collect current from the cathode layer. As the material for the cathode current collector, examples include, but are not limited to, a metal material such as SUS, Ni, Cr, Au, Pt, Al, Fe, Ti and Zn.

As the form of the cathode current collector, examples include, but are not limited to, a foil form, a plate form and a mesh form.

The cathode may further comprise a cathode lead connected to the cathode current collector.

### [Anode]

The anode comprises at least the anode layer. As needed, it may comprise an anode current collector for collecting current from the anode layer.

The anode layer contains at least the anode active material and the phosphorus-based ester compound. As needed, it contains an electroconductive material, a binder, a solid electrolyte, etc.

At least one of the anode layer and the solid electrolyte layer contains a sulfide-based solid electrolyte as the solid electrolyte.

As the anode active material, examples include, but are not limited to, graphite, hard carbon, elemental Li, Li alloy, elemental Si, Si alloy and Li₄Ti₅O₁₂. As the Li alloy and the Si alloy, examples include, but are not limited to, materials exemplified above for the cathode active material.

The form of the anode active material is not particularly limited. As the form, examples include, but are not limited to, a particulate form and a plate form.

The content of the anode active material in the anode layer is not particularly limited. For example, it may be from 20 mass % to 90 mass %.

The phosphorus-based ester compound is at least one selected from the group consisting of a phosphoric acid ester, a phosphonic acid ester, a phosphinic acid ester, a phosphorous acid ester and a phosphoric acid ester amide.

The phosphoric acid ester is represented by the following general formula (1). The phosphonic acid ester is represented by the following general formula (2). The phosphinic acid ester is represented by the following general formula (3). The phosphorous acid ester is represented by the following general formula (4). The phosphoric acid ester amide is represented by the following general formula (5).

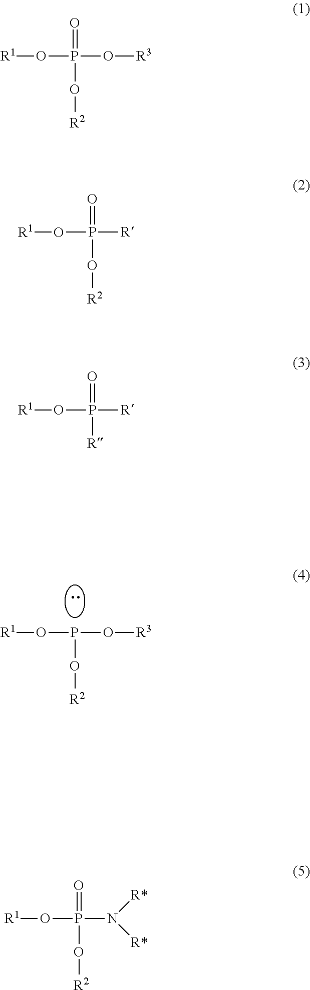

In the general formulae (1) to (5), R¹ to R³ are each independently a group containing at least a carbon element;

the carbon number of R¹ to R³ is within a range of from 1 to 10, for example;

R¹ to R³ may be composed of carbon and hydrogen elements only, and they may also contain another element; R¹ to R³ may be composed of carbon and fluorine elements only, and they may also contain another element; R¹ to R³ may be composed of carbon, hydrogen and fluorine elements only, and they may also contain another element; R¹ to R³ may be a fluorinated alkyl group; all of the hydrogen atoms (H) of the fluorinated alkyl group may be substituted with fluorine atoms; a part of the hydrogen atoms of the fluorinated alkyl group may be substituted with fluorine atoms;

R¹ to R³ may have a chain structure, may have a ring structure (including an aromatic structure) or may have both a chain structure and a ring structure; and the chain structure may be a linear structure or a branched structure.

In the general formulae (1), (2) and (5), R¹ and R² or R¹ and R³ may be substituted with an alkylene group (—R¹⁰—) to form a ring structure;

R′, R″ and R* are directly bound to a phosphorus atom (P) or a nitrogen atom (N); R′, R″ and R* are a hydrogen atom, an alkyl group or an aromatic group; no fluorine atom may be contained in R′, R″ and R*; and when R′, R″ and R* are an alkyl group or an aromatic group, a fluorine atom may be contained in R′, R″ and R*.

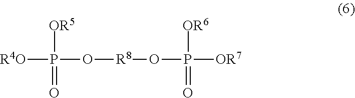

The general formula (6) corresponds to the condensate of a triphosphoric acid ester represented by the general formula (1).

In the general formula (6), R⁴ to R⁸ are each independently a group containing at least a carbon element;

the carbon number of R⁴ to R⁸ is within a range of from 1 to 10, for example;

R⁴ to R⁸ may be composed of carbon and hydrogen elements only, and they may also contain another element; R⁴ to R⁸ may be composed of carbon and fluorine elements only, and they may also contain another element; R⁴ to R⁸ may be composed of carbon, hydrogen and fluorine elements, and they may also contain another element; R⁴ to R⁸ may be a fluorinated alkyl group; all of the hydrogen atoms (H) of the fluorinated alkyl group may be substituted with fluorine atoms; a part of the hydrogen atoms of the fluorinated alkyl group may be substituted with fluorine atoms;

R⁴ to R⁸ may have a chain structure, may have a ring structure (including an aromatic structure) or may have both a chain structure and a ring structure; and the chain structure may be a linear structure or a branched structure.

As the phosphoric acid ester, examples include, but are not limited to, triphenyl phosphate, tris(2,2,2-trifluoroethyl)phosphate, tris(2,2,3,3-tetrafluoropropyl) phosphate, tris(2,2,3,3,3-pentafluoropropyl) phosphate, tris(1H,1H-heptafluorobutyl) phosphate and tris(1H,1H,5H-octafluoropentyl) phosphate.

As the phosphoric acid ester having a ring structure, examples include, but are not limited to, ethylene trifluoroethyl phosphate.

As the phosphoric acid ester, examples include, but are not limited to, bis(2,2,2-trifluoroethyl) methylphosphonate, bis(2,2,2-trifluoroethyl) ethylphosphonate and bis(2,2,2-trifluoroethyl) phosphonate.

As the phosphinic acid ester, examples include, but are not limited to, (2,2,2-trifluoroethyl) diethylphosphinate.

As the phosphorous acid ester, examples include, but are not limited to, tris(2,2,2-trifluoroethyl) phosphite, tris(2,2,3,3-tetrafluoropropyl) phosphite, tris(2,2,3,3,3-pentafluoropropyl) phosphite, tris(1H,1H-heptafluorobutyl) phosphite and tris(1H,1H,5H-octafluoropentyl) phosphite.

As the phosphoric acid ester amide, examples include, but are not limited to, 0,0-bis(2,2,2-trifluoroethyl)N,N-dimethyl phosphate amide ester.

The phosphorus-based ester compound may be liquid or solid at 25° C., and it may be liquid. The liquid phosphorus-based ester compound is disposed to fill the pores (especially, inevitably formed pores) of the anode layer. Accordingly, the thermal stability of the battery can be increased, while maintaining the volumetric energy density thereof. From the viewpoint of battery operation temperature, the phosphorus-based ester compound may be liquid at any temperature in a range of from −20° C. to 100° C., for example, or it may be liquid in the temperature range.

The content of the phosphorus-based ester compound in the anode layer is not particularly limited. For example, the content may be from 0.1 mass % to 20 mass %, or it may be from 1 mass % to 10 mass %.

When the content of the phosphorus-based ester compound in the anode layer is less than 0.1 mass %, there is a possibility that the thermal stability is not sufficiently increased. On the other hand, when the content of the phosphorus-based ester compound in the anode layer is more than 20 mass %, the content of the anode active material is relatively small, and there is a possibility that the capacity of the battery is not sufficient.

As the electroconductive material and binder used in the anode layer, examples include, but are not limited to, materials exemplified above for the cathode layer. As the solid electrolyte used in the anode layer, examples include, but are not limited to, materials exemplified below for the solid electrolyte layer.

The thickness of the anode layer is not particularly limited. For example, it may be from 10 μm to 100 μm.

As the material for the anode current collector, examples include, but are not limited to, a metal material such as SUS, Cu, Ni, Fe, Ti, Co and Zn. As the form of the anode current collector, examples include, but are not limited to, forms exemplified above as the form of the cathode current collector.

### [Solid Electrolyte Layer]

The solid electrolyte layer contains at least the solid electrolyte. As needed, it may contain a binder, etc.

At least any one of the above-described anode layer and solid electrolyte layer contains the sulfide-based solid electrolyte.

As the solid electrolyte, examples include, but are not limited to, a sulfide-based solid electrolyte and an oxide-based solid electrolyte.

The sulfide-based solid electrolyte may comprise a Li element, an A element (A is at least one of P, Ge, Si, Sn, B and Al) and an S element. The sulfide-based solid electrolyte may further comprise a halogen element. As the halogen element, examples include, but are not limited to, an F element, a Cl element, a Br element and an I element. Also, the sulfide-based solid electrolyte may further comprise an O element.

As the sulfide-based solid electrolyte, examples include, but are not limited to, Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—SiS₂—Li₃PO₄ and Li₂S—SiS₂-LiₓMO_{y} (where x and y are positive numbers, and M is P, Si, Ge, B, Al, Ga or In). The “Li₂S—P₂S₅” means a material composed of a raw material composition containing Li₂S and P₂S₅, and the same applies to other solid electrolytes.

The molar ratio of the elements in the sulfide-based solid electrolyte can be controlled by controlling the contents of the elements contained in raw materials. The molar ratio and composition of the elements in the sulfide-based solid electrolyte can be measured by inductively coupled plasma atomic emission spectroscopy, for example.

The sulfide-based solid electrolyte may be sulfide glass, crystallized sulfide glass (glass ceramics) or a crystalline material obtained by developing a solid state reaction of the raw material composition.

The crystal state of the sulfide-based solid electrolyte can be confirmed by X-ray powder diffraction measurement using CuKα radiation, for example.

The sulfide glass can be obtained by amorphizing a raw material composition (such as a mixture of Li₂S and P₂S₅). The raw material composition can be amorphized by mechanical milling, for example.

The glass ceramics can be obtained by heating the sulfide glass, for example.

For the heating, the heating temperature may be a temperature higher than the crystallization temperature (Tc) of the sulfide glass, which is a temperature observed by thermal analysis measurement. In general, it is 195° C. or more. On the other hand, the upper limit of the heating temperature is not particularly limited.

The crystallization temperature (Tc) of the sulfide glass can be measured by differential thermal analysis (DTA).

The heating time is not particularly limited, as long as the desired crystallinity of the glass ceramics is obtained. For example, it is in a range of from one minute to 24 hours, or it may be in a range of from one minute to 10 hours.

The heating method is not particularly limited. For example, a firing furnace may be used.

As the oxide-based solid electrolyte, examples include, but are not limited to, Li₃₊ₓPO₄₋ₓNₓ (where 1≤x≤3) and a substance having a garnet-type crystal structure that includes a Li element, a La element, an A element (A is at least one of Zr, Nb, Ta and Al) and an O element.

The form of the solid electrolyte is not particularly limited. As the form, examples include, but are not limited to, a particulate form and a plate form. From the viewpoint of handling, the form of the solid electrolyte may be a particulate form.

The average particle diameter (D50) of the solid electrolyte particles is not particularly limited. The lower limit may be 0.5 μm or more, and the upper limit may be 2 μm or less.

In the disclosed embodiments, unless otherwise noted, the average particle diameter of particles is a volume-based median diameter (D50) measured by laser diffraction/scattering particle size distribution measurement. Also in the disclosed embodiments, the median diameter (D50) of particles is a diameter at which, when particles are arranged in ascending order of their particle diameter, the accumulated volume of the particles is half (50%) the total volume of the particles (volume average diameter).

As the solid electrolyte, one or more kinds of solid electrolytes may be used. In the case of using two or more kinds of solid electrolytes, they may be mixed together, or they may be formed into layers to obtain a multi-layered structure.

The proportion of the solid electrolyte in the solid electrolyte layer is not particularly limited. For example, it may be 50 mass % or more, may be in a range of 60 mass % or more and 100 mass % or less, may be in a range of 70 mass % or more and 100 mass % or less, or may be 100 mass %.

As the binder used in the solid electrolyte layer, examples include, but are not limited to, materials exemplified above for the cathode layer. The content of the binder in the solid electrolyte layer may be 5 mass % or less, from the viewpoint of, for example, preventing excessive aggregation of the solid electrolyte and making it possible to form the solid electrolyte layer in which the solid electrolyte is uniformly dispersed, for the purpose of easily achieving high power output.

### [Other Components]

As needed, the lithium solid-state battery comprises an outer casing for housing the cathode, the anode and the solid electrolyte layer.

The material for the outer casing is not particularly limited, as long as it is a material that is stable in electrolytes. As the material, examples include, but are not limited to, resins such as polypropylene, polyethylene and acrylic resins.

### [Lithium Solid-State Battery]

The lithium solid-state battery of the disclosed embodiments may be a primary battery or a secondary battery. The lithium solid-state battery may be a secondary battery, since it can be repeatedly charged and discharged and is useful as a car battery, for example. As the form of the lithium solid-state battery, examples include, but are not limited to, a coin form, a laminate form, a cylindrical form and a square form.

The lithium solid-state battery may be produced by the following method, for example. First, the solid electrolyte layer is formed by pressure-forming a powdered solid electrolyte material. Next, the cathode layer is obtained by pressure-forming a powdered cathode mixture containing the oxide-based cathode active material on one surface of the solid electrolyte layer. Then, the anode layer is obtained by pressure-forming a powdered anode mixture containing the anode active material and the phosphorus-based ester compound on the opposite surface of the solid electrolyte layer to the surface on which the cathode layer is formed. As needed, a cathode current collector and an anode current collector are attached thereto, thereby obtaining the lithium solid-state battery.

In this case, the press pressure applied for pressure-forming the powdered solid electrolyte material, the powdered cathode mixture and the powdered anode mixture, is generally about 1 MPa or more and about 600 MPa or less.

The pressing method is not particularly limited. As the pressing method, examples include, but are not limited to, those exemplified above in the formation of the cathode layer.

### EXAMPLES

### Example 1

### [Production of Cathode]

Butyl butyrate was prepared as a solvent. Polyvinylidene fluoride was prepared as a binder. The polyvinylidene fluoride was dissolved in the butyl butyrate to prepare a butyl butyrate solution containing the polyvinylidene fluoride of 5 mass %.

LiNi_{1/3}Co_{1/3}Mn_{1/3}O₂ particles were prepared as a cathode active material.

In the air environment, the surface of LiNi_{1/3}Co_{1/3}Mn_{1/3}O₂ particles was coated with LiNbO₃ by use of a tumbling/fluidizing coater (manufactured by Powrex Corporation). The coated particles were fired in the air environment to coat the surface of the LiNi_{1/3}Co_{1/3}Mn_{1/3}O₂ particles with the LiNbO₃, thereby obtaining a cathode active material composite.

Li₂S—P₂S₅-based glass ceramic was prepared as a solid electrolyte.

Vapor-grown carbon fiber (VGCF) was prepared as a conductive additive.

The butyl butyrate solution, the cathode active material composite, the solid electrolyte and the conductive additive were added in a polypropylene container. These raw materials were stirred for 30 seconds by an ultrasonic disperser (product name: UH-50, manufactured by: SMT Co., Ltd.) Next, the polypropylene container was shaken for 3 minutes by a shaking device (product name: TTM-1, manufactured by: Sibata Scientific Technology Ltd.) The raw materials were further stirred for 30 seconds by the ultrasonic disperser, thereby producing a cathode layer paste. The cathode layer paste was applied on an aluminum foil, which was prepared as a cathode current collector, by the doctor blade method using an applicator. Then, the applied paste was dried on a hot plate at 100° C. for 30 minutes to produce a cathode layer on the cathode current collector, thereby obtaining a cathode including the cathode current collector and the cathode layer.

### [Production of Anode]

Butyl butyrate was prepared as a solvent. Polyvinylidene fluoride was prepared as a binder. The polyvinylidene fluoride was dissolved in the butyl butyrate to prepare a butyl butyrate solution containing the polyvinylidene fluoride of 5 mass %.

An elemental Si powder was prepared as an anode active material.

Li₂S—P₂S₅-based glass ceramic was prepared as a solid electrolyte.

Vapor-grown carbon fiber (VGCF) was prepared as a conductive additive.

Tris(2,2,2-trifluoroethyl) phosphate was prepared as a phosphorus-based ester compound, the content of which in the anode layer is 5 mass % when the total mass of the anode layer is determined as 100 mass %.

The butyl butyrate solution, the anode active material, the solid electrolyte, the conductive additive and the phosphorus-based ester compound were added in a polypropylene container. These raw materials were stirred for 30 seconds by an ultrasonic disperser (product name: UH-50, manufactured by: SMT Co., Ltd.) Next, the polypropylene container was shaken for 3 minutes by a shaking device (product name: TTM-1, manufactured by: Sibata Scientific Technology Ltd.), thereby producing an anode layer paste. The anode layer paste was applied on a copper foil, which was prepared as an anode current collector, by the doctor blade method using an applicator. Then, the applied paste was dried on a hot plate at 100° C. for 30 minutes to produce an anode layer on the anode current collector, thereby obtaining an anode including the anode current collector and the anode layer.

### [Production of Solid Electrolyte Layer]

Heptane was prepared as a solvent. Butadiene rubber was prepared as a binder. The butadiene rubber was dissolved in the heptane to prepare a heptane solution containing the butadiene rubber of 5 mass %.

Li₂S—P₂S₅-based glass ceramic containing lithium iodide was prepared as a solid electrolyte.

The heptane solution and the solid electrolyte were added in a polypropylene container and stirred for 30 seconds by an ultrasonic disperser (product name: UH-50, manufactured by: SMT Co., Ltd.) Next, the polypropylene container was shaken for 30 minutes by a shaking device (product name: TTM-1, manufactured by: Sibata Scientific Technology Ltd.), thereby producing a solid electrolyte layer paste. The solid electrolyte layer paste was applied on an aluminum foil, which was prepared as a substrate, by the doctor blade method using an applicator. Then, the applied paste was dried on a hot plate at 100° C. for 30 minutes to produce a solid electrolyte layer on the aluminum foil.

### [Production of Lithium Solid-State Battery]

The solid electrolyte layer was disposed on the cathode layer of the cathode to bring the solid electrolyte layer into contact with the cathode layer. They were roll-pressed to obtain a first stack of the cathode current collector, cathode layer, solid electrolyte layer and aluminum foil stacked in this order.

Next, the aluminum foil, which was the substrate of the solid electrolyte layer, was peeled off. The anode was disposed on the solid electrolyte layer to bring the solid electrolyte layer into contact with the anode layer, thereby producing a second stack of the cathode current collector, cathode layer, solid electrolyte layer, anode layer and anode current collector stacked in this order. A terminal was attached to the produced second stack. The second stack was laminated by laminate films, thereby producing a lithium solid-state battery.

### Example 2

A lithium solid-state battery was produced in the same manner as Example 1, except that in the above-mentioned [Production of anode], the anode layer was produced by using tris(2,2,2-trifluoroethyl) phosphate as the phosphorus-based ester compound, the content of which in the anode layer is 1 mass % when the total mass of the anode layer is determined as 100 mass %.

### Example 3

A lithium solid-state battery was produced in the same manner as Example 1, except that in the above-mentioned [Production of anode], the anode layer was produced by using tris(2,2,2-trifluoroethyl) phosphate as the phosphorus-based ester compound, the content of which in the anode layer is 10 mass % when the total mass of the anode layer is determined as 100 mass %.

### Example 4

A lithium solid-state battery was produced in the same manner as Example 1, except that in the above-mentioned [Production of anode], the anode layer was produced by using triphenyl phosphate as the phosphorus-based ester compound, the content of which in the anode layer is 5 mass % when the total mass of the anode layer is determined as 100 mass %.

### Example 5

A lithium solid-state battery was produced in the same manner as Example 1, except that in the above-mentioned [Production of cathode], the cathode layer was produced by using tris(2,2,2-trifluoroethyl) phosphate as the phosphorus-based ester compound, the content of which in the cathode layer is 5 mass % when the total mass of the cathode layer is determined as 100 mass %, and the phosphorus-based ester compound was incorporated in both the cathode layer and the anode layer.

### Comparative Example 1

A lithium solid-state battery was produced in the same manner as Example 1, except that in the above-mentioned [Production of anode], the anode layer was produced without the use of the phosphorus-based ester compound.

### Comparative Example 2

A lithium solid-state battery was produced in the same manner as Example 1, except that in the above-mentioned [Production of cathode], the cathode layer was produced by using tris(2,2,2-trifluoroethyl) phosphate as the phosphorus-based ester compound, the content of which in the cathode layer is 5 mass % when the total mass of the cathode layer is determined as 100 mass %, and in the above-mentioned [Production of anode], the anode layer was produced without the use of the phosphorus-based ester compound, thereby incorporating the phosphorus-based ester compound only in the cathode layer.

### [Differential Scanning Calorimetry (DSC) of Simulated Battery]

The lithium solid-state battery obtained in Example 1 was fixed at a predetermined pressure. In an inert atmosphere, the battery was charged at constant current of 0.1 C to 4.55 V.

Next, the lithium solid-state battery was disassembled in an inert atmosphere, while preventing a short circuit, thereby obtaining the charged cathode and anode layers. The cathode and anode layer were cut to a size that can enter a stainless-steel container for DSC, thereby obtaining a sample cathode layer and a sample anode layer. The sample cathode layer was placed in the DSC container. Then, an electrolyte in a plate form was placed on the sample cathode layer. Next, the sample anode layer was placed in the DSC container, while preventing a short circuit. The container was hermetically closed for use as a simulated battery. The hermetically-closed container was installed in a DSC device (manufactured by Shimadzu Corporation), and the thermal behavior of the simulated battery was measured. An empty container was used as a reference. The temperature increase rate was set to 10° C./min, and the end temperature was set to 500° C.

From the results of the DSC, the exothermic peak temperature of the simulated battery was measured. The exothermic peak temperature means a peak temperature at which the heat flow of the thermal behavior was maximum.

In the same manner as the lithium solid-state battery of Example 1, simulated batteries were produced from the lithium solid-state batteries obtained in Examples 2 to 5 and Comparative Examples 1 and 2, and the exothermic peak temperatures thereof were measured. The results are shown in Table 1.

### [Measurement of Direct Current Resistance of Lithium Solid-State Battery]

The lithium solid-state battery obtained in Example 1 was fixed at a predetermined pressure. In an inert atmosphere, the battery was charged at constant current of 0.1 C to 4.55 V.

Next, the lithium solid-state battery was discharged at 0.1 C to 3 V and then charged at constant current and constant voltage (CCCV) of 0.1 C to 3.8 V. Then, the direct current resistance of the lithium solid-state battery was measured.

In the same manner as the lithium solid-state battery of Example 1, the direct current resistances of the lithium solid-state batteries obtained in Examples 2 to 5 and Comparative Examples 1 and 2 were measured. The results are shown in Table 1. In Table 1, the lithium solid-state battery is simply referred to as “battery”.

TABLE 1

| | | Electrode layer | | Exothermic peak | |
|---|---|---|---|---|---|
| | | containing | Content of | temperature (° C.) | Direct current |
| | Phosphorus-based | phosphorus-based | phosphorus-based | of simulated | resistance (Ω) of |
| | ester compound | ester compound | ester compound | battery | battery |
| Example 1 | Tris(2,2,2-trifluoroethyl) | Anode layer | 5 Mass % | 365 | 16.9 |
| | phosphate | | | | |
| Example 2 | Tris(2,2,2-trifluoroethyl) | Anode layer | 1 Mass % | 360 | 17.1 |
| | phosphate | | | | |
| Example 3 | Tris(2,2,2-trifluoroethyl) | Anode layer | 10 Mass % | 367 | 17.2 |
| | phosphate | | | | |
| Example 4 | Triphenyl phosphate | Anode layer | 5 Mass % | 355 | 17.6 |
| Example 5 | Tris(2,2,2-trifluoroethyl) | Cathode layer and | 5 Mass % | 365 | 17.2 |
| | phosphate | anode layer | (cathode layer) & | | |
| | | | 5 mass % | | |
| | | | (anode layer) | | |
| Comparative | None | None | — | 350 | 17.8 |
| Example 1 | | | | | |
| Comparative | Tris(2,2,2-trifluoroethyl) | Cathode layer | 5 Mass % | 347 | 18.2 |
| Example 2 | phosphate | | | | |

As shown in Table 1, the exothermic peaks of the simulated batteries observed in the DSC of Examples 1 to 5 and Comparative Examples 1 and 2, are thought to be caused by a reaction of the oxygen generated from the pyrolytically-decomposed cathode active material with the charged anode layer.

The exothermic peak temperatures of the simulated batteries of Examples 1 to 5 were compared to the exothermic peak temperatures of the simulated batteries of Comparative Examples 1 and 2. As a result, it was found that the exothermic peak temperatures of the simulated batteries of Examples 1 to 5 shifted to the higher temperature side than the exothermic peak temperatures of the simulated batteries of Comparative Examples 1 and 2. Since the phosphorus-based ester compound has a function of a flame retardant, it is thought that the oxygen-induced decomposition reaction of the anode active material is suppressed by adding the phosphorus-based ester compound to the anode layer, and the thermal stability of the lithium solid-state battery is increased.

From the results of Comparative Example 2, it was found that in the case of adding the phosphorus-based ester compound only to the cathode layer, the direct current resistance of the lithium solid-state battery increases compared to the case of Comparative Example 1 in which the phosphorus-based ester compound was not added. This is thought to be because the phosphorus-based ester compound in the cathode layer is decomposed by exposing the cathode layer to high temperature during the charge and discharge of the lithium solid-state battery.

From the results of Examples 1 to 5, it was revealed that an increase in the resistance of the lithium solid-state battery is suppressed by adding the phosphorus-based ester compound to at least the anode layer. The reason is not clear yet.

From the above results, it was found that by adding the phosphorus-based ester compound to at least the anode layer, the thermal stability of the lithium solid-state battery is increased, and an increase in the resistance is suppressed.

### REFERENCE SIGNS LIST

11. Solid electrolyte layer
12. Cathode layer
13. Anode layer
14. Cathode current collector
15. Anode current collector
16. Cathode
17. Anode
100. Lithium solid-state battery

1. A lithium solid-state battery comprising:
a cathode comprising a cathode layer that contains an oxide-based cathode active material, an anode comprising an anode layer that contains an anode active material, and a solid electrolyte layer being disposed between the cathode layer and the anode layer and containing a solid electrolyte,
wherein at least any one of the anode layer and the solid electrolyte layer contains a sulfide-based solid electrolyte, and
wherein the anode layer contains at least one phosphorus-based ester compound selected from the group consisting of a phosphoric acid ester, a phosphoric acid ester, a phosphinic acid ester, a phosphorous acid ester and a phosphoric acid ester amide.

2. The lithium solid-state battery according to claim 1, wherein a content of the phosphorus-based ester compound in the anode layer is 1 mass % or more and 10 mass % or less when a total mass of the anode layer is determined as 100 mass %.

3. The lithium solid-state battery according to claim 1, wherein the anode active material is at least one selected from the group consisting of elemental Si and Si alloy.

4. The lithium solid-state battery according to claim 1, wherein the phosphorus-based ester compound contains a fluorinated alkyl group.
